(19) United States
(12) Patent Application Publication
(10) Pub. No.: US 2012/0007805 A1
(43) Pub. Date: Jan. 12, 2012

(54) TOUCH SCREEN CAPABLE OF DISPLAYING A POINTER

(76) Inventor: Youn Soo Kim, Seoul (KR)

(21) Appl. No.: 13/257,167

(22) PCT Filed: Mar. 12, 2010
(86) PCT No.: PCT/KR2010/001542

§ 371 Date: Sep. 16, 2011

(30) Foreign Application Priority Data
Mar. 19, 2009 (KR) 10-2009-0023583

(51) Int. Cl. G06F 3/033

(52) U.S. Cl. 345/159; 345/157

(57) ABSTRACT

A touch screen including a display unit on which a pointer is displayed and a touch-sensing unit mounted on the display unit to generate a display position signal of the pointer when brought into contact with a separate contact medium. The display unit changes the display position of the pointer in accordance with the drag direction of the contact medium when the contact medium, which stays in contact with the touch-sensing unit, is dragged. Accordingly, the pointer being displayed is movable, and the moving speed and migration length of the pointer can be adjusted according to the selection of a user to achieve improved convenience in use. The touch screen may simplify structure and achieve aesthetic enhancement by eliminating the necessity of a touch pad for moving the pointer.

### RELATED APPLICATIONS

This application is a 35 U.S.C. §371 national phase application of PCT Application No. PCT/KR2010/001542, filed Mar. 12, 2010, which claims priority to Korean Patent Application No. 10-2009-0023583. The entire contents of both of the above applications are hereby incorporated by reference.

### FIELD OF THE INVENTION

The present invention relates, in general, to a touch screen for displaying a pointer thereon and, more particularly, to a touch screen configured to cause the pointer to be displaced by a user's operation.

### BACKGROUND

There has been the recent trend, because various mobile communication terminals such as cellular phones or PMPs (Portable Multimedia Player) have employed touch screens as a display unit, to eliminate various key pads and arrow keys that function as conventional input devices and for a user to be able to directly touch the touch screen to input various characters or signals.

Since the touch screen from which various key pads and arrow keys have been eliminated does not have the function of inputting a direction, a mouse pointer has not been displayed on the touch screen. However, as Internet or game capabilities have recently been incorporated into the cellular phone or PMP, there is a demand for utilizing the mouse pointer in the touch screen.

In order to meet such a demand, a mobile telecommunication terminal which includes a touch screen for displaying the mouse pointer thereon and a separate touch pad for displacing the mouse pointer has been proposed. The touch pad detects the distance that a user's finger moves relative to the touch pad while in contact with the touch pad and generates a signal that causes the mouse pointer to be displaced on the touch screen in proportion to the displacement distance and a velocity.

### SUMMARY

If the separate touch pad is provided as mentioned above, miniaturization of the product becomes subject to a limitation. In addition, since the operation of pressing the touch screen and the operation of displacing the pointer are performed in different places, many inconveniences in use are caused. Also, the distance which the pointer moves on the touch screen is typically set to be larger than the distance that the user's finger moves on the touch pad, so that it is difficult to move the pointer to the correct place.

Further, the user cannot correctly anticipate how far to drag the finger across the touch pad to move the pointer to the desired place. Accordingly, this is the source of an inconvenience when used.

Embodiments of the present invention have been made keeping in mind the above problems occurring in the related art, and provide a touch screen capable of displaying the displacement of the pointer by inputting a signal onto the touch screen without using a separate touch pad.

Accordingly, embodiments of the present invention provide a touch screen including a display unit on which a pointer is displayed; and a touch-sensing unit mounted on the display unit to generate a display position signal of the pointer when brought into contact with a separate contact medium, and the display unit is configured to change the display position of the pointer in accordance with the drag direction of the contact medium when the contact medium, which stays in contact with the touch-sensing unit, is dragged.

The display unit can change the display position of the pointer in a predetermined direction and speed having a vector value matching to that of the drag direction and speed of the contact medium.

The display unit can display the pointer on a point of the touch-sensing unit corresponding to the contact point at which the contact medium is touched.

The display unit can display the pointer on a point of the touch-sensing unit spaced apart from the contact point of the contact medium.

The display unit can change the display position of the pointer by a distance that is obtained by amplifying the drag distance of the contact medium by a predetermined proportion.

The display unit can display the pointer when the contact medium first makes contact with the touch-sensing unit.

The touch screen may further include a pressure sensor for sensing a contact pressure at which the contact medium is applied to the touch-sensing unit, and as the contact medium is dragged across the touch-sensing unit, the display unit is configured to increase or decrease the displacement distance of the display position of the pointer by applying a weight value to the magnitude of the contact pressure of the contact medium applied to the touch-sensing unit.

In other aspect, there is provided a touch screen including a display unit on which a pointer is displayed. Also, a touch-sensing unit is mounted on the display unit to generate a display position signal of the pointer when brought into contact with a separate contact medium. Also, the display unit is configured to change the position at which the pointer is displayed in a direction from one reference point set on the touch-sensing unit toward a contact point of the touch-sensing unit that the contact medium is put into contact with.

A reference point mark can be displayed at a point of the display unit which corresponds to the reference point.

The signal input function can be activated when the contact medium is put in contact with the point of the touch-sensing unit corresponding to the reference point mark.

The display unit can displace the display position of the pointer by a predetermined distance, regardless of the distance between the reference point and the contact point.

The display unit can change the display position of the pointer in accordance with the contact number in which the contact medium makes contact with the touch-sensing unit.

The display unit can increase or decrease in proportion to the time that the contact medium remains in contact with the touch-sensing unit.

The touch screen may further include a pressure sensor configured to sense a contact pressure of the contact medium applied to the touch-sensing unit, and the display unit is configured to increase or decrease the distance by which the position at which the pointer is displayed changes by applying a weighted value to the magnitude of the contact pressure that the contact medium pushes against the touch-sensing unit.

The point at which the contact medium makes first contact with the touch-sensing unit can be set as the reference point and the point at which the contact medium makes contact with the touch-sensing unit after setting the reference point can be set as the contact point.

The display unit can display the pointer when the contact medium first makes contact with the touch-sensing unit.

In another aspect, there is provided a touch screen including a display unit on which a pointer is displayed; a touch-sensing unit mounted on the display unit to generate a display position signal of the pointer when the display unit is brought into contact with a separate contact medium; and a pressure sensor for sensing the contact pressure that the contact medium applies to the touch-sensing unit, and when the contact pressure is applied at an angle so as to have a vertical pressure component and a horizontal pressure component, the display unit is configured to increase or decrease the displacement distance of the display position of the pointer by displacing the display position of the pointer in a direction of the horizontal pressure component and applying a weight value on the magnitude of the vertical pressure component.

The touch screen of embodiments of the present invention are useful because, among other reasons, the pointer is movable when displayed, and the moving speed and travel distance of the pointer can be adjusted by the selection of a user to improve the convenience when being used. Also, the touch screen of embodiments of the present invention may simplify structure and achieve an aesthetic enhancement as it eliminates the necessity of having to use a touch pad to move the pointer.

### BRIEF DESCRIPTION OF THE DRAWINGS

FIG. 1 is a vertical sectional view illustrating a touch screen according to the present invention.

FIG. 2 is a vertical sectional view illustrating the operational principle of the touch screen according to the present invention.

FIGS. 3 to 8 are plan views illustrating an example in which the touch screen according to the present invention is used.

FIG. 9 is a vertical sectional view illustrating a touch screen according to a second embodiment of the present invention.

FIG. 10 is a vertical sectional view illustrating the operational principle of the touch screen according to the second embodiment of the present invention.

FIGS. 11 and 12 are plan views illustrating an example in which the touch screen according to the second embodiment of the present invention is used.

### DETAILED DESCRIPTION

Hereinafter, a touch screen according to embodiments of the present invention will be described in detail with reference to the accompanying drawings.

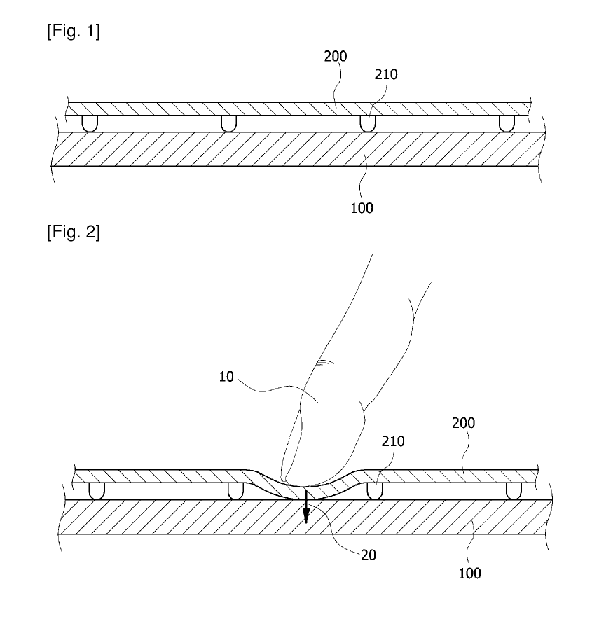

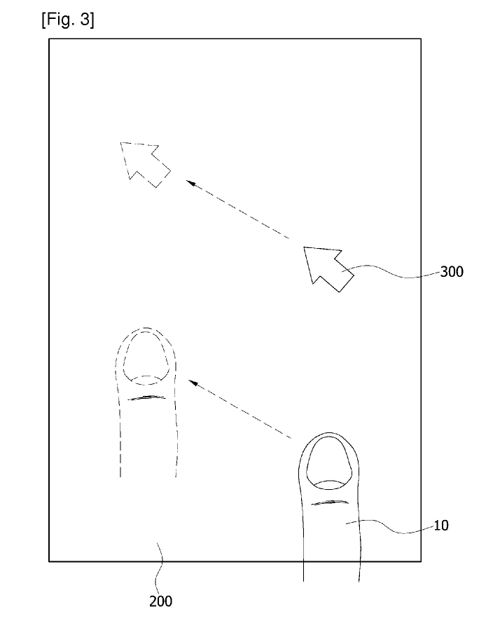

FIG. 1 is a vertical sectional view illustrating a touch screen according to embodiments of the present invention; FIG. 2 is a vertical sectional view illustrating the operational principle of the touch screen according to embodiments of the present invention, and FIGS. 3 to 8 are plan views illustrating an example in which the touch screen according to embodiments of the present invention is used.

As shown in FIGS. 1 and 2, the touch screen according to embodiments of the present invention includes a display unit 100 on which a pointer 300 is displayed and a touch-sensing unit 200 mounted on the display unit 100 to generate a display position signal indicating the pointer 300 when a separate contact medium 10 is brought into contact with the display unit 100 (although a user's finger is illustrated as the contact medium in FIG. 2, the user's finger may be replaced by a means such as a stylus pen). Specifically, the display unit 100 and the touch-sensing unit 200 are normally spaced away from each other by a spacer 210, as shown in FIG. 1. And, as shown in FIG. 2, when the contact medium 10 is pressed down on the touch-sensing unit 200 by a contact pressure 20 so that the touch-sensing unit 200 makes contacts with the display unit 100, the position signal of the contact medium 10 is generated. Of course, a detecting layer is provided on a top surface of the display unit 100 to detect the contact of the touch-sensing unit 200.

As shown in FIGS. 1 and 2, since the structure in which the touch-sensing unit 200 is put into contact with the display unit 100 by the contact pressure 20 of the contact medium 10 to generate an input signal is similar to a Resistive Overlay type of touch screen, a detailed description thereof will be omitted.

Meanwhile, the touch screen according to embodiments of the present invention is characterized in that when the contact medium 10 is dragged across the touch-sensing unit 200 while being in contact therewith, the display unit 100 is configured to change the display position of the pointer 300 in a predetermined direction and speed using a vector value matching that of the drag direction and speed of the contact medium 10. Specifically, the display unit 100 is configured to display the pointer 300 in a trace to follow the movement of the contact medium 10.

As such, in the touch screen according to embodiments of the present invention, it is possible to displace the pointer 300 by the operation of dragging the contact medium 10 such as the user's finger or stylus pen on a top surface of the touch screen (specifically, a top surface of the touch-sensing unit 200) without having to use a separate touch pad. Accordingly, there is the merit that embodiments of the touch screen may simplify structure and achieve an aesthetic enhancement. In the prior art of providing a separate touch pad, the point on which the user applies contact pressure and the point at which the pointer 300 is displayed are remote from each other, so that it is difficult to correctly display the pointer 300 on one certain point of the display unit. In contrast, the touch screen according to embodiments of the present invention is adapted to allow the contact pressure to be applied on the display unit, so that it is possible to easily and correctly display the pointer 300 on one certain point of the display unit.

In this regard, as shown in FIG. 3, the display unit 100 can display the pointer 300 at a point of the touch-sensing unit 200 corresponding to the contact point of the contact medium 10. However, in this case, there is the drawback of the pointer 300 being hidden by the contact medium 10 so that it is difficult to correctly identify the position of the pointer 300.

Accordingly, in order to prevent the contact medium 10 and the pointer 300 from overlapping each other, as shown in FIG. 3, it is preferred that the pointer be displayed on a point of the touch-sensing unit 200 spaced away from the contact point of the contact medium 10. In this way, when the contact medium 10 and the pointer 300 are spaced apart from each other, there is the advantage that a user can easily identify the correct position of the pointer 300 and thus convenience of use is significantly enhanced.

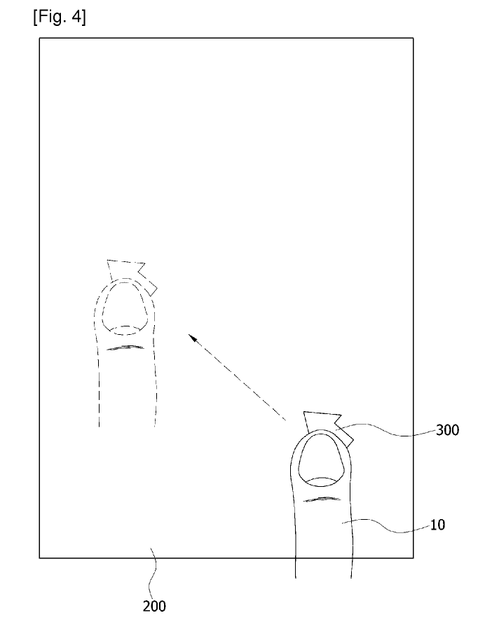

Further, FIG. 4 illustrates the case of the drag distance of the contact medium 10 corresponding to the displacement distance of the pointer 300. However, the drag distance of the contact medium 10 and the displacement distance of the pointer 300 may be set to have different values. That is, the display unit 100 can change the display position of the pointer 300 by a distance that is obtained by amplifying the drag distance of the contact medium 10 by a predetermined proportion. As such, when the displacement distance of the pointer 300 is set to larger than the drag distance of the contact medium 10 as mentioned above, there is the advantage of the user being able to displace the pointer 300 to a farther away place by slightly moving the contact medium 10 and thus the convenience of use is enhanced.

The touch screen according to embodiments of the present invention is not limited to the structure in which the pointer 300 is displaced by dragging the contact medium 10. The touch screen may be configured to displace the pointer 300 by operating the contact medium 10 in various different ways.

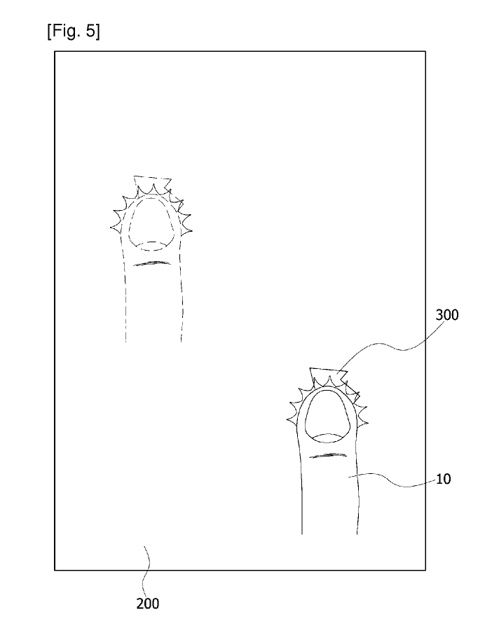

Specifically, as shown in FIG. 5, the display unit 100 may have a structure wherein the pointer 300 is displayed at a point (shown in solid line in FIG. 5) of the display unit in which the contact medium 10 first makes contact with the touch-sensing unit 200 and the pointer is displayed at a new touch place of the display unit when the contact medium is put in contact with another place of the touch-sensing unit 200. As such, when the pointer 300 is displayed at a location that follows the contact place of the contact medium 10, there is the advantage of the point 300 being able to be displaced to a place farther away quickly and thus rapid response is possible.

Embodiments of the present invention may have a structure wherein the display position of the pointer 300 is changed in the direction going from one reference point set on the touch-sensing unit 200 towards a contact point of the touch-sensing unit at which the contact medium 10 is making contact.

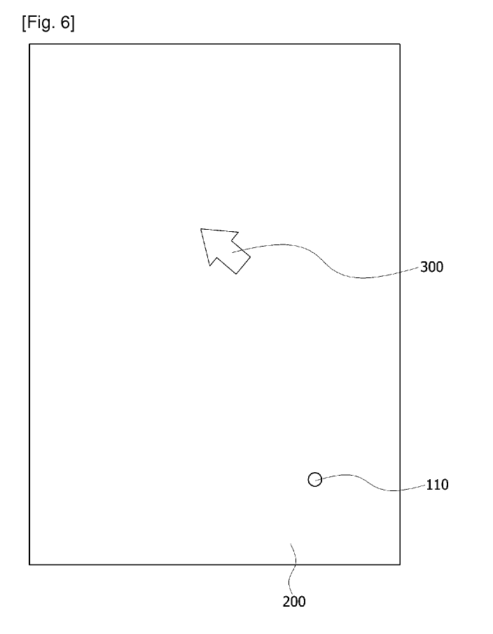

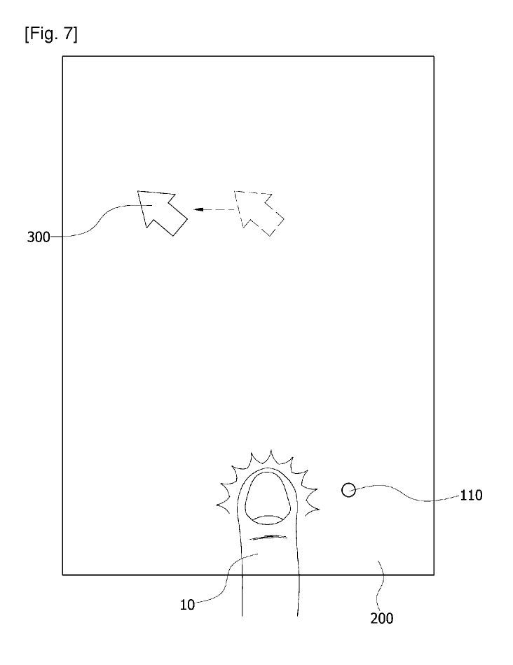

For example, FIG. 6 shows a reference point mark 110 that is displayed at a point of the display unit 100 which corresponds to the reference point set on the touch-sensing unit 200. In this state, as shown in FIG. 7, when a user contacts the contact medium 10 at a point which is a distance away from the reference point mark 110, the pointer 300 is displayed on a position (left side in FIG. 7) which is displaced from the reference point mark 110 in the direction going towards the contact point. Specifically, the reference point mark 110 is one reference point set on the touch-sensing unit 200 mentioned above and the touch point of the contact medium 10 is the contact point mentioned above. Accordingly, the pointer 300 is displayed at a point which is displaced from the reference point in a direction towards the contact point.

In addition, as shown in FIG. 7, when the contact medium 10 comes into contact with the display unit one more time in the state shown in FIG. 7, the pointer 300 on the display unit is displaced from the position shown in FIG. 7 further towards the left side. Specifically, when a user brings the contact medium 10 into repeated contact with a point spaced apart from the reference point mark 110 to the left, the display position of the pointer 300 is continuously displaced further towards the left side.

At this time, the reference point mark 110 is not limited to the function of indicating the moving reference point of the pointer 300 and can realize a signal input function (for example, functioning as an enter key) when the contact medium 10 contacts the reference point mark. In this way, if the signal input function is realized when the contact medium 10 contacts the reference point mark 110, a user touches a point spaced from the reference point mark 110 to displace the pointer 300, and then the user touches the reference point mark 110 when the pointer 300 reaches the target point, so that a function similar to the operation of clicking a mouse button can be realized.

In this regard, as the contact medium 10 contacts a contact point spaced away from the reference point mark 110, the displacement distance of the display position of the pointer 300 can be set to various values.

For example, the display position of the pointer 300 may be displaced by a predetermined distance, regardless of the distance between the reference point mark 110 and the contact point, or may be displaced in proportion to the distance between the reference point mark 110 and the contact point. Alternatively, the display position of the pointer may be displaced in proportion to the time that the contact medium 10 is in contact with the touch-sensing unit 200.

When the display position of the pointer 300 is displaced by a predetermined distance, regardless of the distance between the reference point mark 110 and the contact point, the operation of contacting the contact medium 10 on the touch-sensing unit 200 to displace the pointer 300 achieves the same effect as the operation of utilizing arrow keys to displace the pointer 300. Accordingly, even if separate arrow keys are eliminated, the touch screen according to embodiments of the present invention can perform various games or word processing in which the pointer 300 should be displaced in vertical and lateral directions. For reference, although an example in which the pointer 300 is indicated as a mouse cursor is illustrated in this embodiment, the pointer 300 can be used to indicate an input cursor in a word processing program or a game unit.

Further, when the distance that the display position of the pointer 300 moves is realized in different ways, there is the merit of a user being able to freely regulate the displacement distance of the display position of the pointer 300 within a narrower range.

Meanwhile, although an example in which the reference point mark 110 just serves as a reference point is illustrated in this embodiment, it is possible to set the reference point in various ways. For example, a point at which a user first touches the touch-sensing unit 200 can be used as the reference point and a point at which a user makes second contact with the touch-sensing unit 200 can be set as the contact point. As such, when the position of the reference point is set according to the selection of a user, the pointer can be displaced in a desired direction and displayed at a target position without identifying the contact point of the contact medium 10 on the display unit with the unaided eye.

Furthermore, a point at which the contact medium 10 first comes into contact with the touch-sensing unit 200 can be set as the reference point, and all points at which the contact medium 10 is in contact with the touch-sensing unit 200 after setting the reference point can be set as the contact point.

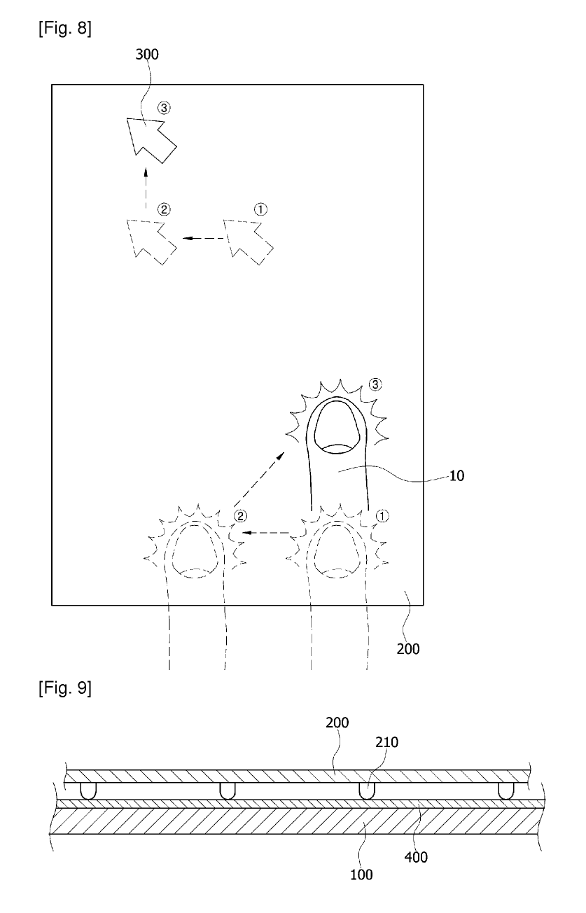

Specifically, as shown in FIG. 8, the \textcircled{1} point on which the contact medium 10 first makes contact with the touch-sensing unit 200 becomes the reference point and the \textcircled{2} point on which the contact medium 10 makes second contact with the touch-sensing unit 200 becomes the first contact point, so that the pointer 300 moves to the left. In a state of setting the reference point as mentioned above, the \textcircled{3} point at which the contact medium 10 makes contact a third time with the touch-sensing unit 200 becomes the second contact point, so that the pointer 300 moves further. At this time, although the \textcircled{3} point is displaced rightwards and upwards relative to the \textcircled{2} point, the pointer 300 dose not move rightwards and upwards but moves upwards based on a calculation value in which a direction of the \textcircled{3} point relative to the \textcircled{1} point as the reference point is calculated.

At this time, the display unit 100 can display the pointer 300 at a point of the touch-sensing unit 200 which corresponds to the reference point and the contact point. However, in this case, the pointer 300 can be hidden by the contact medium 10 so that it may become inconvenient to use. Accordingly, as shown in FIGS. 6 and 7, it is preferable that the display unit 100 is configured to display the pointer 300 on the point of the touch-sensing unit 200 which is spaced away from the reference point and the contact point.

Further, in order to move the display position of the pointer 300 to a remote spot even if the contact medium 10 touches a point slightly spaced away from the reference point, the display unit 100 can displace the display position of the pointer 300 by a distance which is obtained by amplifying the distance between the reference point and the contact point by a predetermined proportion.

In addition, in respective embodiment shown in FIGS. 3 to 7, the pointer 300 can be displayed on the display unit 100 before the contact medium 10 makes contact with the touch-sensing unit 200. However, when the pointer 300 is always displayed even when the pointer 300 is not necessary, there is the drawback that the pointer 300 may cover the view of the display unit 100. Accordingly, it is preferable that the pointer 300 be displayed when the contact medium 10 makes first contact with the touch-sensing unit 200.

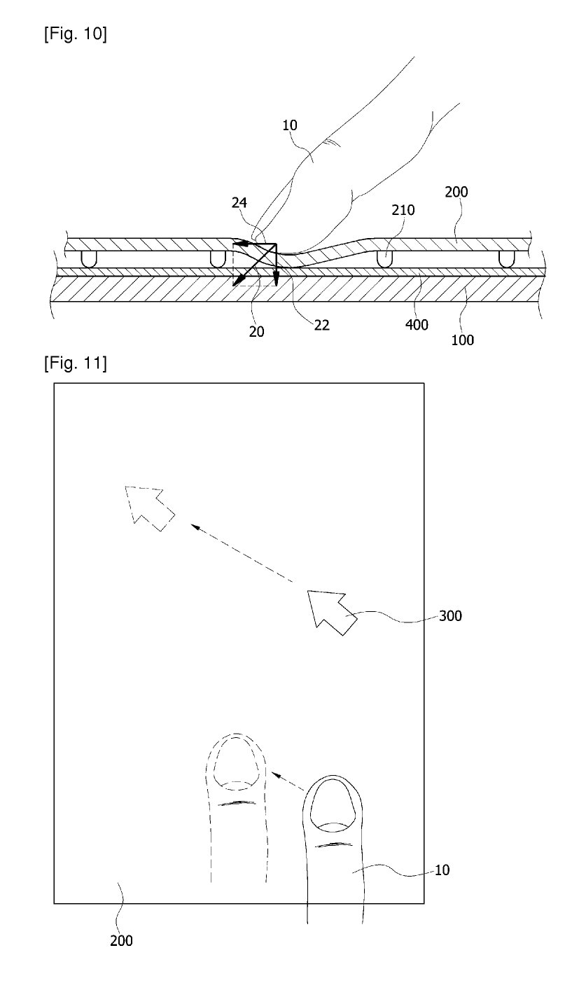

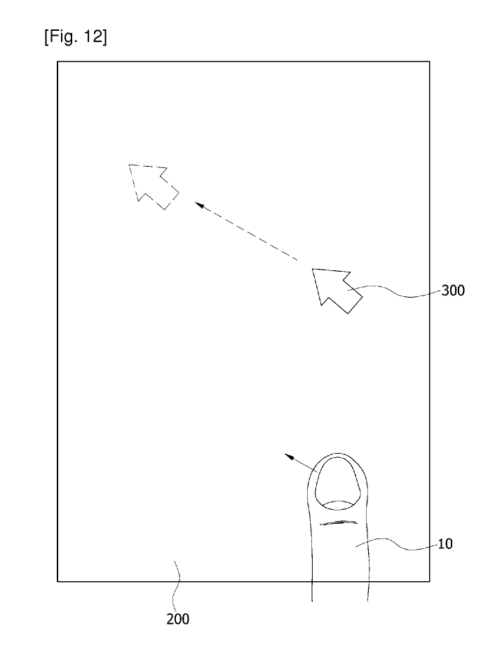

FIG. 9 is a vertical sectional view illustrating a touch screen according to a second embodiment of the present invention; FIG. 10 is a vertical sectional view illustrating the operational principle of the touch screen according to the second embodiment of the present invention; and FIGS. 11 and 12 are plan views illustrating an example in which the touch screen according to the second embodiment of the present invention is used.

As shown in FIG. 9, the touch screen according to embodiments of the present invention can further include a pressure sensor 400 which is mounted between the display unit 100 and the touch-sensing unit 200 to sense a contact pressure of the contact medium 10 applied to the touch-sensing unit 200.

When the contact pressure 20 is applied at an angle, the pressure sensor 400 can measure respectively a vertical pressure component 22 of the contact pressure perpendicular to the top surface of the display unit 100 and a horizontal pressure component 24 of the contact pressure parallel to the top surface of the display unit 100. For reference, since when the contact pressure is applied at an angle, the pressure sensor capable of respectively measuring a vertical pressure component of the contact pressure and a horizontal pressure component of the contact pressure is well known for various applications, the operational principle and details of the pressure sensor 400 will be omitted. As such, when the pressure sensor 400 is also provided, there is the effect of a user being able to carry out additional functions in accordance with the pressing level on which the contact medium 10 is pressed on the touch-sensing unit 200 by the user.

For example, as shown in FIG. 11, as the contact medium 10 is dragged along the touch-sensing unit while pressing the touch-sensing unit 200 at an angle, the display unit 100 can increase or decrease the displacement distance of the display position of the pointer 300 by displacing the display position of the pointer 300 in a direction of the horizontal pressure component 24 and applying a weighted value to the magnitude of the vertical pressure component 22. Specifically, when the contact medium 10 is dragged with a relatively low contact pressure 20, the display unit 100 is configured to displace the display position of the pointer 300 by a distance slightly larger than the distance that the contact medium 10 is dragged. And, when the contact medium 10 is dragged at a very high contact pressure 20, the display unit 100 is configured to displace the display position of the pointer 300 by a distance several times greater than the distance the contact medium 10 was dragged.

Since the touch screen according to embodiments of the present invention is configured as mentioned above, there is the merit that a user can freely regulate the moving speed of the pointer 300 by regulating the pressure which is applied to the touch-sensing unit 200 by the contact medium 10.

For not only the type in which the contact medium 10 is dragged but also the type in which the contact medium 10 touches a point spaced away from the reference point, as shown in FIGS. 6 to 8, it is possible to freely regulate the moving speed of the pointer 300 by regulating the pressure applied to the touch-sensing unit 200 by the contact medium 10.

Meanwhile, when the pressure sensor 400 is also provided, even if the contact medium 10 is not displaced, it is possible to displace the pointer 300 only by making the direction of the contact pressure 20 of the contact medium 10 relative to the top surface of the display unit 100 be at an angle.

Specifically, as shown in FIG. 12, when the contact medium 10 applies contact pressure 20 to the touch-sensing unit 200 while being slanted to the left and upwards, the pressure sensor 400 detects the vertical pressure component 24 of the contact pressure 20 and the display unit 100 can displace the display position of the pointer 300 in a direction of the horizontal pressure component 22 applied on the touch-sensing unit 200.

When the pressure sensor 400 and the display unit 100 are configured as mentioned above, a user can displace the pointer 300 in various directions just by changing the direction of the contact medium 10 while the contact medium 10 is stopped on one point of the touch-sensing unit 200.

Also, in a case shown in FIG. 12, it is preferable that the display unit 100 be configured to increase or decrease the displacement distance of the display position of the pointer 300 by applying a weighted value to the magnitude of the vertical pressure component 22.

Meanwhile, although the case of the touch screen according to embodiments of the present invention being of the resistive overlay type was described above, the touch screen according to embodiments of the present invention can be applied to various types of touch screens including an electrostatic capacity type and an infrared type. Further, it is also possible to regulate the moving speed of the pointer by further providing the pressure sensor mentioned above to an electrostatic capacity type or an infrared type of touch screen.

Hereinabove, although the present applicant has described some preferred specific embodiments herein, these embodiments are only exemplary embodiments of the present invention. It should be noted that various modifications and variations of the present invention fall within the scope of the present invention.

The touch screen of embodiments of the present invention is advantageous in that, among other benefits, it is useful as the pointer being displayed is movable, and the moving speed and migration length of the pointer can be adjusted according to the selection of a user.

1-17. (canceled)

18. A touch screen comprising:
a display unit on which a pointer is displayed at a display position; and
a touch-sensing unit mounted on the display unit to generate a display position signal of the pointer when a separate contact medium is brought into contact with the touch-sensing unit,
wherein the display unit is configured to change the display position of the pointer in accordance with a direction in which the contact medium is dragged when the contact medium, which remains in contact with the touch-sensing unit, is dragged a drag distance.

19. The touch screen according to claim 18, wherein the display unit is configured to change the display position of the pointer in a predetermined direction and speed having a vector value matching that of the direction in which the contact medium is dragged and a speed with which the contact medium is dragged.

20. The touch screen according to claim 19, wherein the display unit is configured to display the pointer at a point of the touch-sensing unit corresponding to a contact point of the contact medium.

21. The touch screen according to claim 19, wherein the display unit is configured to display the pointer at a point of the touch-sensing unit spaced apart from a contact point of the contact medium.

22. The touch screen according to claim 18, wherein the display unit is configured to change the display position of the pointer by a distance that is obtained by amplifying the drag distance of the contact medium by a predetermined proportion.

23. The touch screen according to claim 18, wherein the display unit is configured to display the pointer thereon when the contact medium first makes contact with the touch-sensing unit.

24. The touch screen according to claim 18, further comprising a pressure sensor for sensing a contact pressure of the contact medium applied to the touch-sensing unit,
wherein, as the contact medium is dragged across the touch-sensing unit, the display unit is configured to increase or decrease a displacement distance of the display position of the pointer by applying a weighted value to the magnitude of the contact pressure of the contact medium applied to the touch-sensing unit.

25. A touch screen comprising:
a display unit on which a pointer is displayed at a position; and
a touch-sensing unit mounted on the display unit to generate a display position signal of the pointer when a separate contact medium is brought into contact with the touch-sensing unit,
wherein the display unit is configured to change the display position of the pointer (300) in a direction from a reference point set on the touch-sensing unit towards a contact point of the touch-sensing unit in which the contact medium is in contact.

26. The touch screen according to claim 25, wherein a reference point mark is displayed on a point of the display unit which corresponds to the reference point.

27. The touch screen according to claim 26, wherein a signal input function is realized when the contact medium is in contact with a point of the touch-sensing unit corresponding to the reference point mark.

28. The touch screen according to claim 25, wherein the display unit is configured to displace the display position of the pointer by a predetermined distance, regardless of the distance between the reference point and the contact point.

29. The touch screen according to claim 25, wherein the display unit is configured to change the display position of the pointer in accordance with the number of times that the contact medium makes contact with the touch-sensing unit.

30. The touch screen according to claim 25, wherein the display unit is configured to increase or decrease an amount of displacement of the display position of the pointer in proportion to a time over which the contact medium is in contact with the touch-sensing unit.

31. The touch screen according to claim 25, further comprising a pressure sensor configured to sense a magnitude of a contact pressure of the contact medium applied to the touch-sensing unit,
wherein the display unit is configured to increase or decrease a distance that the display position of the pointer moves by applying a weighted value to the magnitude of the contact pressure of the contact medium applied to the touch-sensing unit.

32. The touch screen according to claim 25, wherein a point at which the contact medium makes first contact with the touch-sensing unit is set as the reference point and a point at which the contact medium makes contact with the touch-sensing unit after setting the reference point is set as the contact point.

33. The touch screen according to claim 25, wherein the display unit is configured to display the pointer when the contact medium is first brought into contact with the touch-sensing unit.

34. A touch screen comprising:
a display unit on which a pointer is displayed;
a touch-sensing unit mounted on the display unit to generate a display position signal of the pointer when a separate contact medium is brought into contact with the touch-sensing unit; and
a pressure sensor for sensing a contact pressure of the contact medium applied to the touch-sensing unit,
wherein when the contact pressure is applied at an angle so as to have a vertical pressure component and a horizontal pressure component, the display unit is configured to increase or decrease a displacement distance of the display position of the pointer by displacing the display position of the pointer in a direction of the horizontal pressure component and applying a weighted value to a magnitude of the vertical pressure component.
